(19) United States
(12) Patent Application Publication
(10) Pub. No.: US 2011/0264602 A1
(43) Pub. Date: Oct. 27, 2011

(54) Computer-Implemented Systems And Methods For Implementing Dynamic Trading Strategies In Risk Computations

(76) Inventors: Donald James Erdman, Raleigh, NC (US); Wei Chen, Apex, NC (US); Steve Krueger, Raleigh, NC (US); Scott Thomas Gray, Raleigh, NC (US); Brent Allen Smolinski, Peachtree City, GA (US)

(21) Appl. No.: 12/893,408

(22) Filed: Sep. 29, 2010

Related U.S. Application Data
(60) Provisional application No. 61/326,890, filed on Apr. 22, 2010.

(51) Int. Cl. G06Q 40/00

(52) U.S. Cl. 705/36 R

(57) ABSTRACT

Systems and methods are provided for simulating a portfolio risk of a portfolio managed according to one or more portfolio management rules. An initial holding amount of an investment instrument is received, and a portfolio management rule is received. One or more risk factors are simulated a first time period into the future. An adjustment amount is determined based on the portfolio management rule and the one or more risk factors simulated a first time period into the future and the holding amount of the investment instrument is adjusted based on adjustment amount. The one or more risk factors are simulated a second time period into the future, and a portfolio risk value is calculated based on the adjusted holding amount and the one or more risk factors simulated a second time period into the future.

### CROSS REFERENCE TO RELATED APPLICATIONS

This application claims priority to U.S. Provisional Application No. 61/326,890, filed Apr. 22, 2010, entitled “Computer-Implemented Systems and Methods for Implementing Dynamic Trading Strategies in Risk Computations.” The entirety of which is herein incorporated by reference.

### FIELD

The technology described herein relates generally to portfolio management and more specifically to risk calculation in portfolio management.

### BACKGROUND

In conducting portfolio management, it is often desirable to identify the risk involved with certain investments to help determine the attractiveness of an investment instrument or combination of investment instruments. For example, one may desire to identify a value at risk associated with an investment portfolio. A value at risk measure (VaR) summarizes the worst loss over a target horizon with a given level of confidence. FIG. 1 depicts a distribution of 400 projected returns on a portfolio. Based on the distribution of FIG. 1, the worst expected portfolio return with 95% confidence is −3.5%. With a portfolio valued at $100M, the worst expected portfolio return results in a value at risk measure of $3.5M.

### SUMMARY

Systems and methods are provided for simulating a portfolio risk of a portfolio managed according to one or more portfolio management rules. An initial holding amount of an investment instrument may be received, and a portfolio management rule may be received. One or more risk factors may be simulated a first time period into the future. An adjustment amount is determined based on the portfolio management rule and the one or more risk factors simulated a first time period into the future and the holding amount of the investment instrument may be adjusted based on the adjustment amount. The one or more risk factors may be simulated a second time period into the future, and a portfolio risk value may be calculated based on the adjusted holding amount and the one or more risk factors simulated a second time period into the future.

As another example, a system may include a data processor and a computer-readable memory, where the computer-readable memory includes instructions for commanding the data processor to perform a method. In the method, an initial holding amount of an investment instrument may be received, and a portfolio management rule may be received. One or more risk factors may be simulated a first time period into the future. An adjustment amount is determined based on the portfolio management rule and the one or more risk factors simulated a first time period into the future and the holding amount of the investment instrument may be adjusted based on the adjustment amount. The one or more risk factors may be simulated a second time period into the future, and a portfolio risk value may be calculated based on the adjusted holding amount and the one or more risk factors simulated a second time period into the future.

As a further example, a computer-readable memory may be encoded within instructions for commanding a data processor to perform a method. In the method, an initial holding amount of an investment instrument may be received, and a portfolio management rule may be received. One or more risk factors may be simulated a first time period into the future. An adjustment amount is determined based on the portfolio management rule and the one or more risk factors simulated a first time period into the future and the holding amount of the investment instrument may be adjusted based on the adjustment amount. The one or more risk factors may be simulated a second time period into the future, and a portfolio risk value may be calculated based on the adjusted holding amount and the one or more risk factors simulated a second time period into the future.

### BRIEF DESCRIPTION OF THE DRAWINGS

FIG. 1 depicts a distribution of projected returns on a portfolio.

FIG. 2 depicts a computer-implemented environment for simulating a portfolio risk of a portfolio managed according to one or more portfolio management rules.

FIG. 3 is a flow diagram depicting a process for calculating a value at risk using a Monte Carlo simulation.

FIG. 4 is a diagram depicting the results of a Monte Carlo simulation for a value at risk calculation.

FIG. 5 is a flow diagram depicting a process for calculating a value at risk using a Monte Carlo simulation that incorporates dynamic portfolio management.

FIGS. 6 and 7 are tables describing an example Monte Carlo simulation of portfolio risk of a portfolio managed according to one or more portfolio management rules.

FIG. 8 is a flow diagram depicting a computer-implemented method for simulating a portfolio risk of a portfolio managed according to one or more portfolio management rules.

FIGS. 9A, 9B, and 9C depict example systems for a portfolio risk.

### DETAILED DESCRIPTION

FIG. 2 depicts at 100 a computer-implemented environment for simulating a portfolio risk of a portfolio managed according to one or more portfolio management rules. A user 102 interacts with a portfolio simulator 104 to determine how much risk is involved with a portfolio managed according to a strategy represented by one or more portfolio management rules 114.

In traditional risk management, portfolios are assumed static (e.g., they do not change over time and market states). While this assumption may be appropriate for market risk management over a short time horizon, such an approach may be undesirable in other contexts where longer time horizons are the focus. Thus, a portfolio simulator 104 may enable a risk management system that better accommodates the dynamic nature of a portfolio.

Dynamic trading strategies allow one to track risk over time, rather than using a static framework with a single time step or a model for extrapolating risk. Trading strategies can be modeled through event-based rules. For example, arbitrary rules may be applied that take any information from a scenario and use that information to adjust the portfolio, resulting in a portfolio whose composition is both time-dependent and scenario-dependent to more accurately represent an actively managed portfolio. Stop-loss orders, delta hedging, duration matching, and other strategies may be represented by one or more portfolio management rules that can be simulated by a portfolio simulator. The introduction of dynamic trading strategies enables tools of risk management, such as Monte Carlo simulation, historical simulation, covariance simulation, scenario simulation, and stress testing to be applied to asset/liability and credit management situations. Such valuation models that account for portfolio effects can significantly improve the accuracy of calculations. A dynamic portfolio may be modeled utilizing one or more portfolio management rules. Such rules may be easy to communicate and can capture the nature of a firm's behavior, while being robust under uncertainty.

The users 102 can interact with the portfolio simulator 104 through a number of ways, such as over one or more networks 108. Server(s) 106 accessible through the network(s) 108 can host the portfolio simulator 104. One or more data stores 110 can store the data to be analyzed by the portfolio simulator 104 as well as any intermediate or final data generated by the portfolio simulator 104. The one or more data stores 110 may contain many different types of data associated with the process, including risk factor data 112, portfolio management rules 114, as well as other data. The portfolio simulator 104 can be an integrated web-based reporting and analysis tool that provides users flexibility and functionality for simulating a portfolio risk. It should be understood that the portfolio simulator 104 could also be provided on a stand-alone computer for access by a user 102.

A portfolio may include financial instruments, such as stocks, options, and futures; credit instruments, such as loans, bonds, and options; commodities, such as gas, pork bellies, and wheat; and currencies, such as the Japanese Yen, the U.S. Dollar, and the British Pound. The value of a portfolio may be calculated according to the following formula:

$$Val = {\sum }_{i = 1}^{N} {h}_{i} {p}_{i} ( {rf}_{1} , {rf}_{2} , … , {rf}_{R} ) ,$$

where N is the number of instruments in the portfolio, R is the number of risk factors, rfⱼ is the value of risk factor j, hᵢ is the number of holdings of instrument i, and pᵢ(rf₁, rf₂, . . . , rf_{R}) represents the value (price) of instrument i, as a function of risk factors 1 . . . R.

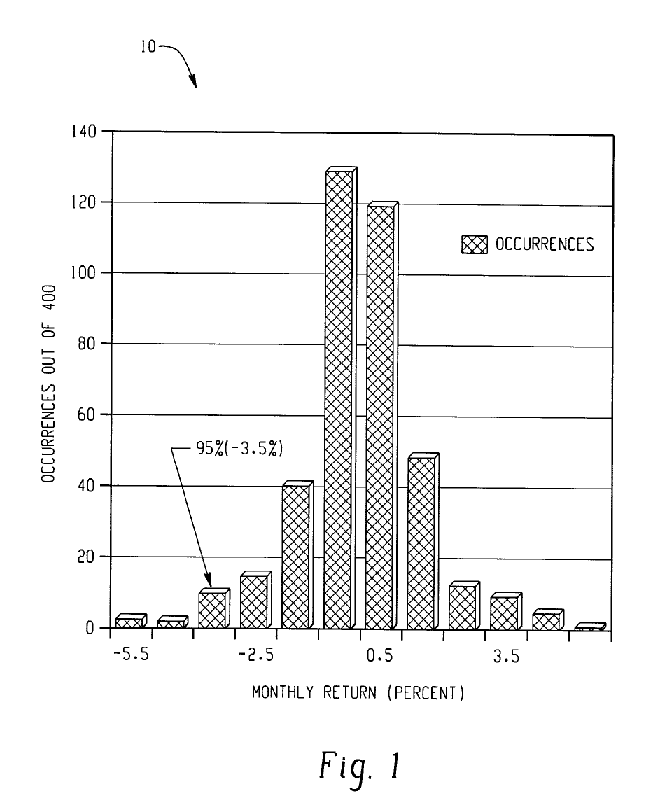

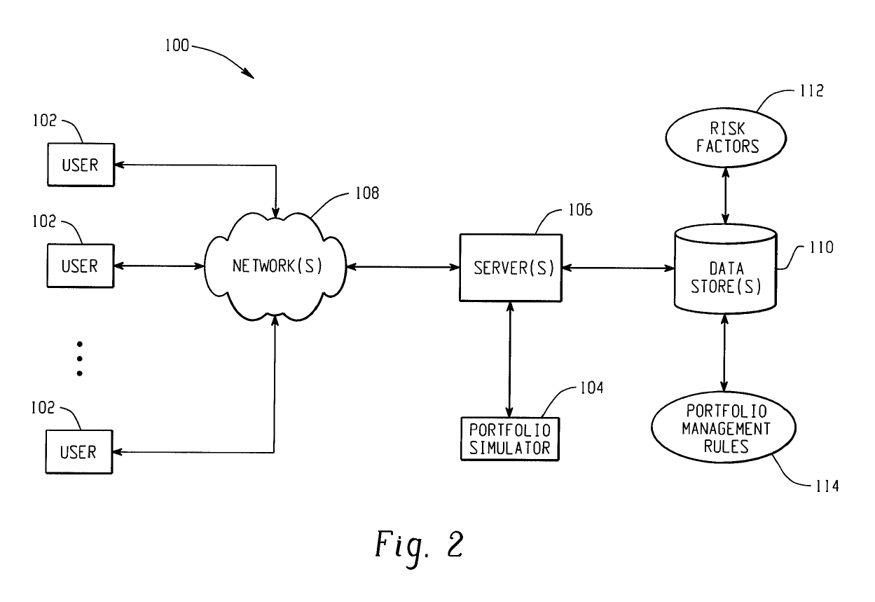

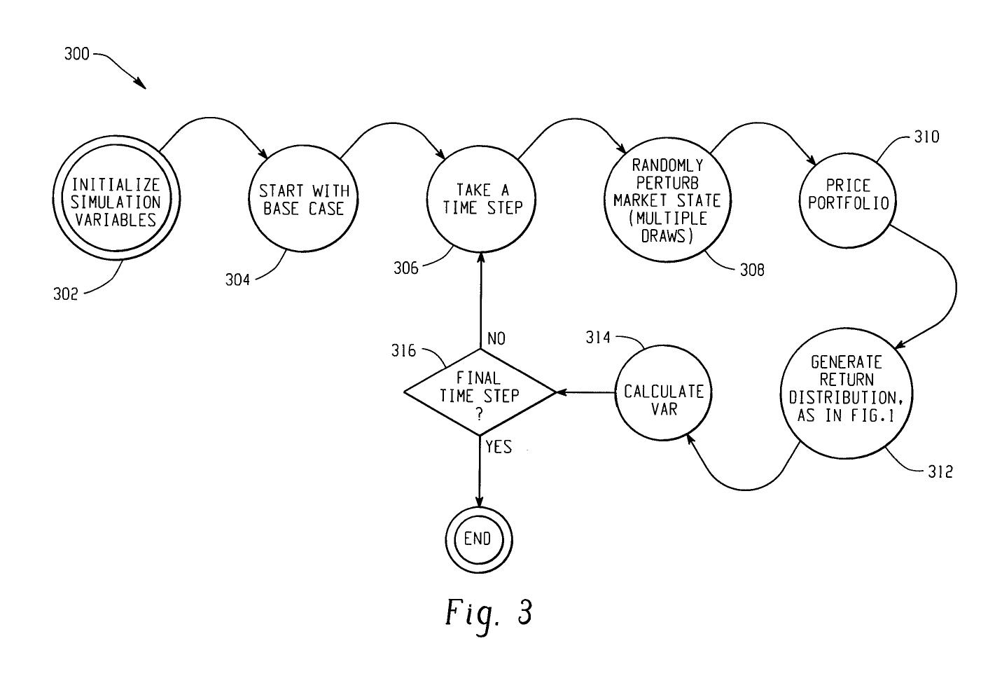

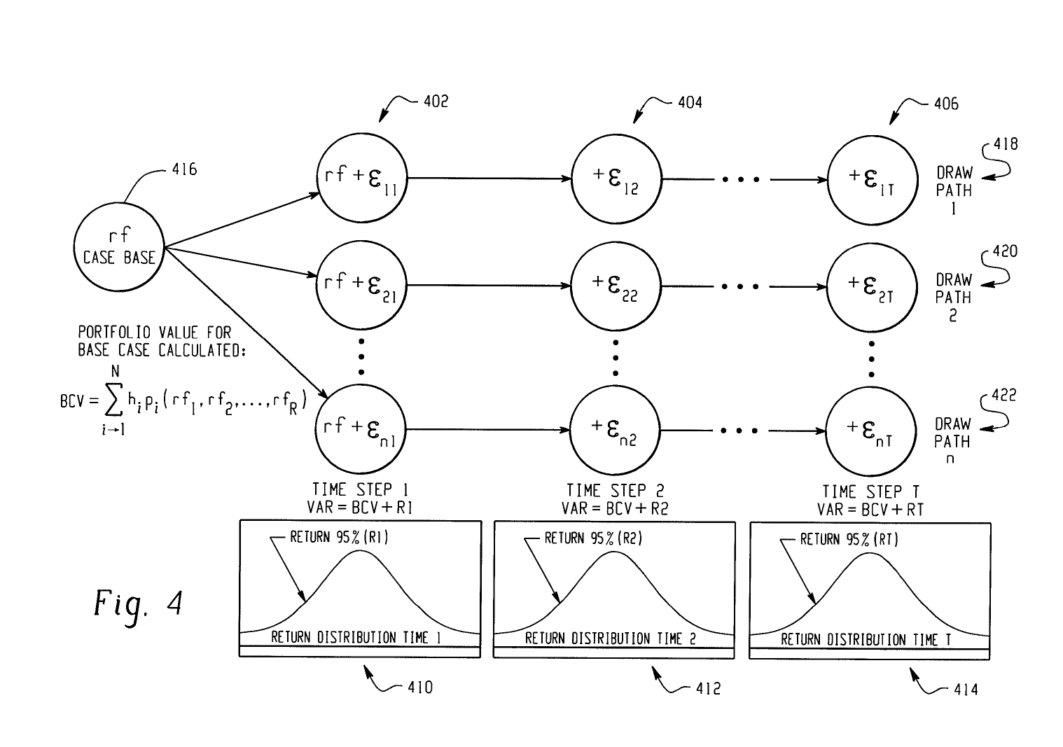

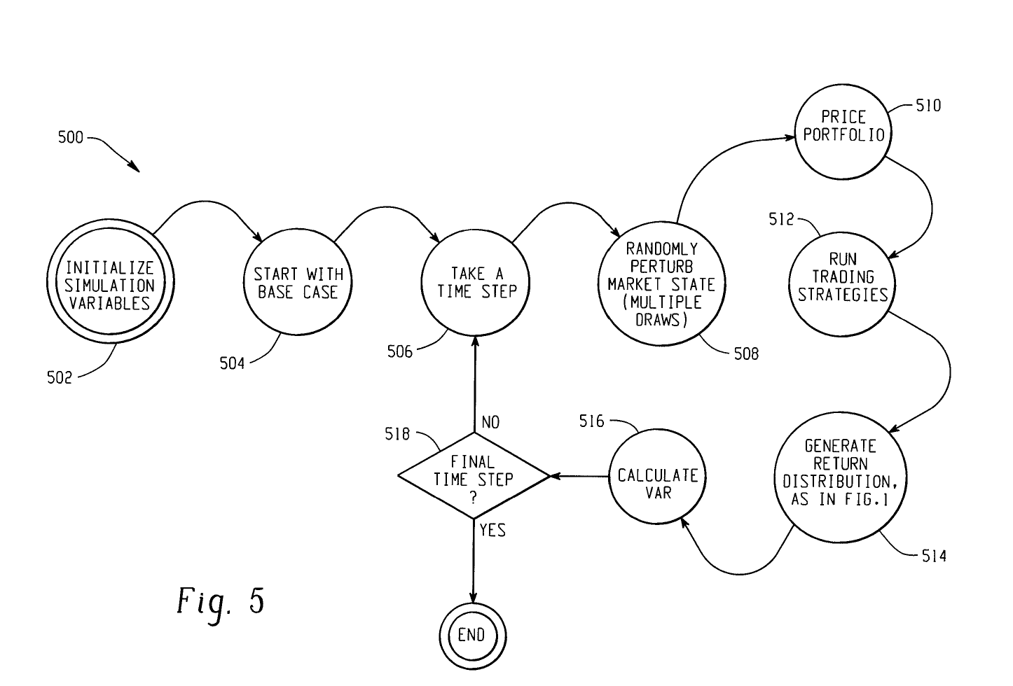

FIG. 3 is a flow diagram depicting a process for calculating a value at risk using a Monte Carlo simulation. At 302, the system is initialized to include the time horizon for the simulation (T), the size of the time step to be taken at each generation t, where t<T, and the number of draws to be taken at each time step, n. The system is primed with a base case at 304. For example, the base case may include starting values for all of the risk factors, instruments, holdings, and initial portfolio value. A time step is taken at 306, where, at 308, each risk factor is perturbed n times from the base case, giving n simulated market states at a first time period in the future, where rf_{j,d,1}=rf_{j,0,0}+ε_{j,d,1}, where rf_{j,d,t} is the value of risk factor j along draw path d in {1, 2, . . . , n} at time t, ε_{j,d,t} is a random adjustment computed from a random draw, and rf_{j,0,0} is the base case value for risk factor j. At 310, for each of the simulated market states d in {1, 2, . . . , n}, the portfolio is priced, and the return on the portfolio is calculated relative to the base case, assuming a constant holding hᵢ for the time period between t=0 and t=1. A return distribution may be calculated at 312, such as is shown above with respect to FIG. 1, and a value at risk may be calculated at time step 1 at 314 by picking a confidence level α, finding the worst return at that confidence level, and multiplying that return by the value of the base case portfolio. At 316, for each step {2 . . . T}, steps 306, 308, 310, 312, and 314 may be repeated where draws made at 308 follow a path: rf_{j,d,t}=rf_{j,d,(t-1})+ε_{j,d,t}.

FIG. 4 is a diagram depicting the results of a Monte Carlo simulation for a value at risk calculation. At each step 402, 404, 406 in the simulation, a corresponding value at risk 410, 412, 414 is calculated relative to the base case 416. For example, the value at risk may be calculated by generating a distribution at each step 402, 404, 406 of portfolio values calculated based on risk factor values of each draw 418, 420, 422 at that step. The generated distribution at a step may then be analyzed to determine a worst case return scenario with a certain degree of confidence, such as 95%. That worst case return at the desired confidence may be applied to the base portfolio value to calculate the value at risk.

The value of the examples described above may be somewhat limited in that the holdings of the portfolios are assumed to be constant at each step. This assumption may not be realistic for longer time horizons (e.g., greater than 2 days), where adjustments to the portfolio may be made, such as is the case in credit risk and asset liability management. FIG. 5 is a flow diagram depicting a process for calculating a value at risk using a Monte Carlo simulation that incorporates dynamic portfolio management.

At 502, the system is initialized to include the time horizon for the simulation (T), the size of the time step to be taken at each generation t, where t≦T, and the number of draws to be taken at each time step, n. The system is primed with a base case at 504. For example, the base case may include starting values for all of the risk factors, instruments, holdings, and initial portfolio value. A time step is taken at 506, where, at 508, each risk factor is perturbed n times from the base case, giving n simulated market states at a first time period in the future, where rf_{j,d,1}=rf_{j,0,0}+ε_{j,d,1}, where rf_{j,d,t} is the value of risk factor j along draw path d in {1, 2, . . . , n} at time t, ε_{j,d,t} is a random adjustment computed from a random draw, and rf_{j,0,0} is the base case value for risk factor j.

At 510, for each of the simulated market states d in {1, 2, . . . , n}, the portfolio is priced. At 512, trading strategies may be run. For example, trading strategies may be represented by one or more portfolio management rules that are evaluated at 512. A collection of one or more portfolio management decision rules can be used to represent a user's (firm's) behavior. Implementations of rules can leverage a broad range of technologies, such as from the field of artificial intelligence. A decision rule may take the form of if ( . . . ) then ( . . . ). The decision rule has a left side and a right side. The left side is matched against what is true in the world (facts) or what is believed to be true (beliefs). The right hand side describes what actions should be taken given the left hand side is, or is believed to be, true. Facts can be represented using predicate logic, first-order logic, or higher order logics. Beliefs may be represented by belief networks, neural networks, or any reasoning technology such as probabilistic or deterministic. Actions may be many things, such as asserting new facts about the world, updating databases, updating beliefs, computing results.

Decision rules can be grouped to form portfolio management trading strategies. The rules within a trading strategy can execute within an expert system. Expert systems are very good for modeling expert behavior. An expert system may allow rules to run in parallel, represent knowledge through higher order logics, reach inferences through forward chaining, and construct facts through backward chaining. Expert systems may also simplify the construction of robust rules and allow for efficient execution of forward chaining, such as via the CLIPS system. The use of forward chaining may capture non-linear relationships between rules.

With reference back to FIG. 5, running trading strategies at 512 may include evaluating one or more portfolio management rules based on the one or more risk factors simulated a first time period into the future at 508. The trading strategy execution at 512 may further include adjusting the holding amount h_{i,d,t} for instrument i along draw path d at time step t based on the evaluation of the one or more portfolio management rules. A return distribution may be calculated at 514 and a value at risk may be calculated at time step 1 at 516 by picking a confidence level α, finding the worst return at that confidence level, and multiplying that return by the value of the base case portfolio. At 518, for each step {2 . . . T}, steps 506, 508, 510, 512, 514 and 516 may be repeated where draws made at 508 follow a path: rf_{j,d,t}=rf_{j,d(t-1)}+ε_{j,d,t}.

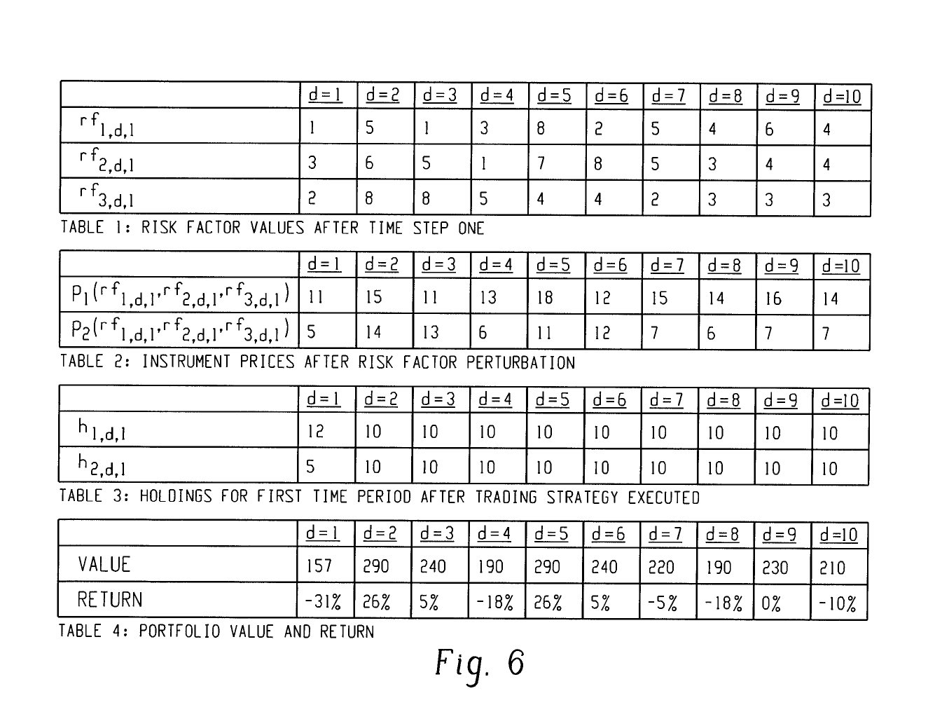

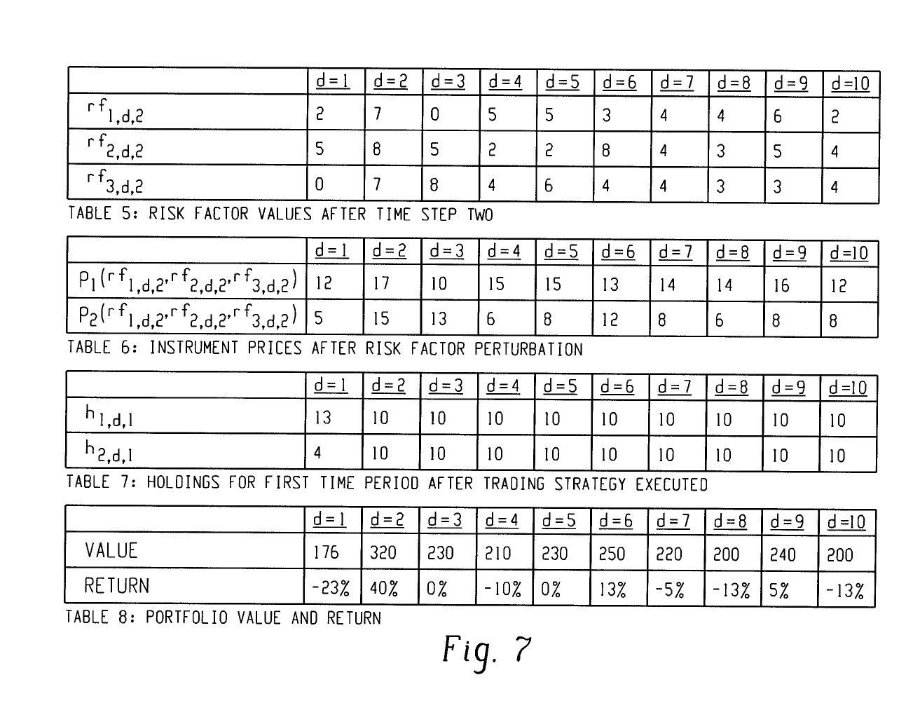

FIGS. 6 and 7 are tables describing an example Monte Carlo simulation of portfolio risk of a portfolio managed according to one or more portfolio management rules. In this example, two instruments are utilized, each with an initial holding of 10. The simulation is performed over two time steps with ten random draw paths taken over those two steps. The example seeks to calculate a value at risk with a 90% confidence based on three factors. It is assumed that a limitless amount of cash is available to buy and sell shares. The initial state for the example is as follows:

Holding 1: h_{1,0,0}=10;

Holding 2: h_{2,0,0}=10;

Price of holding 1: p₁(rf₁, rf₂, rf₃)=rf₁+10;

Price of holding 2: p₂(rf₁, rf₂, rf₃)=rf₂+rf₃;

Time steps: s=2;

Draws: d=10.

The risk factors and prices of the holdings at t=0 are:

rf_{1,0,0}=4

rf_{2,0,0}=2

rf_{3,0,0}=7

p₁(rf_{1,0,0},rf_{2,0,0},rf_{3,0,0})=14

p₂(rf_{1,0,0},rf_{2,0,0},rf_{3,0,0})=11,

which results in an initial portfolio value of (14*10)+(9*10)=230. The following portfolio management rules are to be applied as a trading strategy for the simulation:

1. if p₂(rf_{1,d,s},rf_{2,d,s},rf_{3,d,s})≦5 then h_{2,d,s}=½h_{2,d,(s-1)} and h_{1,d,s}=h_{1,d,(s-1)}+2; and

2. if h_{1,d,s}−h_{2,d,s}≧10 then h_{2,d,s}=h_{2,d,(s-1)}+1 and h_{1,d,s}=h_{1,d,(s-1)}−1.

Table 1, depicted in FIG. 6 illustrates ten sets of random draws, d={1 . . . 10}, for each of the three risk factors rf₁, rf₂, and rf₃. Table 2 depicts an evaluation of the price of holding 1, p₁, and the price of holding 2, p₂, at t=1 for each of the ten draws based on the drawn risk factor variables. For example, evaluating p₁ and p₂ for draw d=1 based on the drawn risk factor values rf_{1,1,1}=1, rf_{2,1,1}=3, and rf_{3,1,1}=2 calculates a price of holding 1 of p₁=11 and a price of holding 2 of p₂=5. Table 3 depicts the state of the holdings for the first time period after the trading strategy is executed, as depicted at 512 in FIG. 5. For example, based on the first portfolio management rule, because the price of holding 2, p₂, is equal to 5 for draw d=1, then the number of instruments of holding 2, h_{2,1,1}, is halved and the number of instruments of holding 1, h_{1,1,1}, is increased by 2. Table 4 depicts a calculation of the portfolio value and return for each of the ten draws at time t=1 as compared to the initial portfolio value of 230. As described above, the portfolio value may be calculated according to:

$$Val = {\sum }_{i = 1}^{N} {h}_{i} {p}_{i} ( {rf}_{1} , {rf}_{2} , … , {rf}_{R} ) .$$

The value at risk calculation for the first time step is calculated based on the confidence level of 90%. In this example, the worst return at a 90% confidence interval is −31% at draw d=1, which corresponds with a value at risk of 73.

Table 5, depicted in FIG. 7, depicts a second set of ten draws from the t=1 values for the three risk factors. Table 6 depicts a calculation of the price of holding 1, p₁, and the price of holding 2, p₂, at t=2 for each of the ten draws. Table 7 depicts an evaluation of the two portfolio rules and the adjustment of the holdings based on that evaluation. For example, for draw d=1, based on the first portfolio management rule, because the price of holding 2 is equal to 5, the amount of holding 2, h_{2,1,2} is halved to three, and the amount of holding 1, h_{1,1,2}, is increased to 14. Based on the second portfolio management rule, because the difference in the amount of holding 1 and the amount of holding 2 is greater than ten, then the amount of holding 1 is increased by 1 to 4, and the amount of holding 2 is decreased by 1 to 13. Table 8 depicts a calculation of the portfolio value and return at time t=2 as compared to the initial portfolio value of 230. The value at risk may be computed for the second time based on the confidence interval of 90%. The worst return at a 90% confidence interval is −23%, which results in a value at risk of 54.

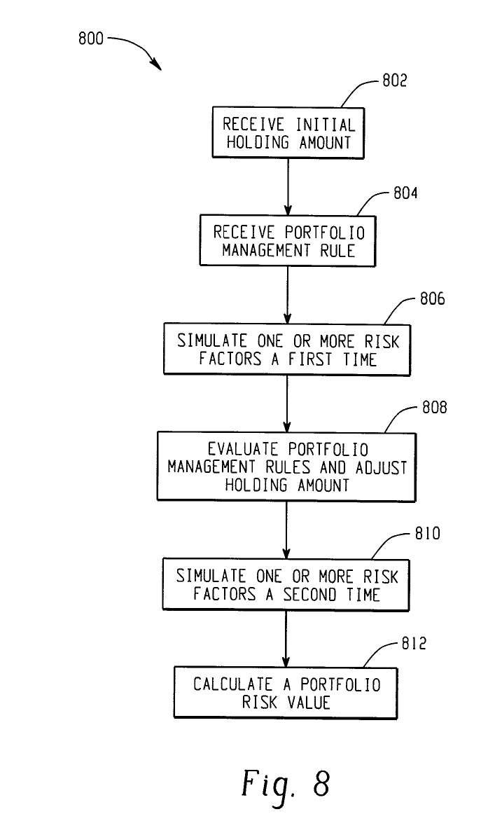

FIG. 8 is a flow diagram depicting a computer-implemented method for simulating a portfolio risk of a portfolio managed according to one or more portfolio management rules. An initial holding amount of one or more investment instruments is received at 802. At 804, one or more portfolio management rules are received, and at 806, one or more risk factors are simulated a first time period into the future. At 808, the one or more portfolio management rules are evaluated based on the one or more risk factors simulated a first time period into the future, and the holding amounts of the one or more investment instruments are adjusted based on the evaluation of the portfolio management rules. At 810, the one or more risk factors are simulated a second time period into the future, and at 812, a portfolio risk value is calculated based on the adjusted holding amounts and the one or more risk factors simulated a second time period into the future. For example, the portfolio risk value may be a value at risk, an expected return, a portfolio value variance, a portfolio value standard deviation, an expected return confidence interval, an expected portfolio value, as well as others.

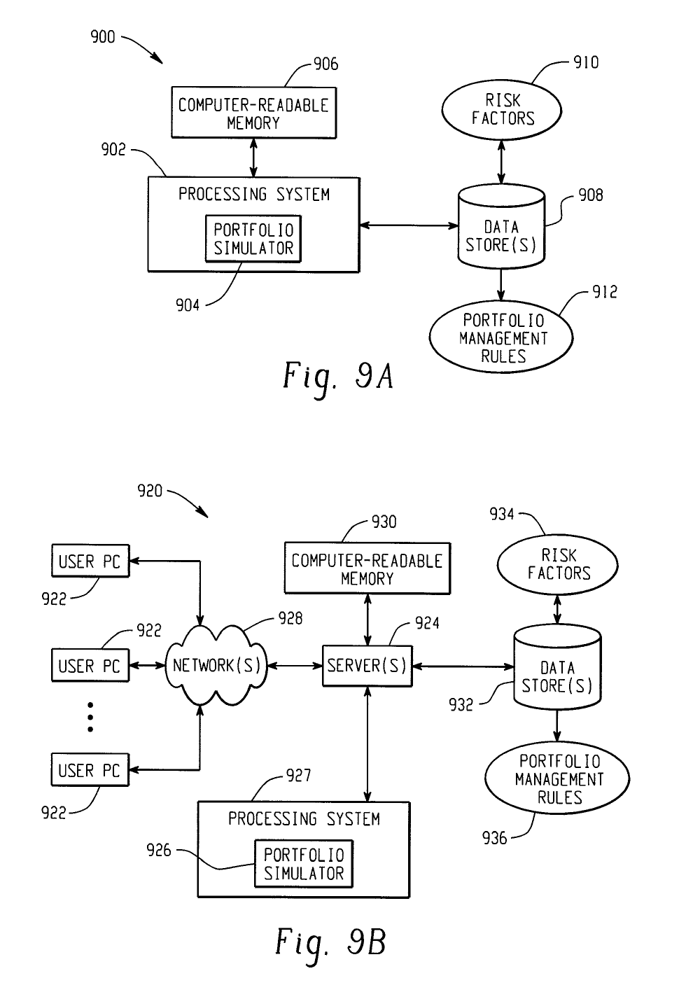

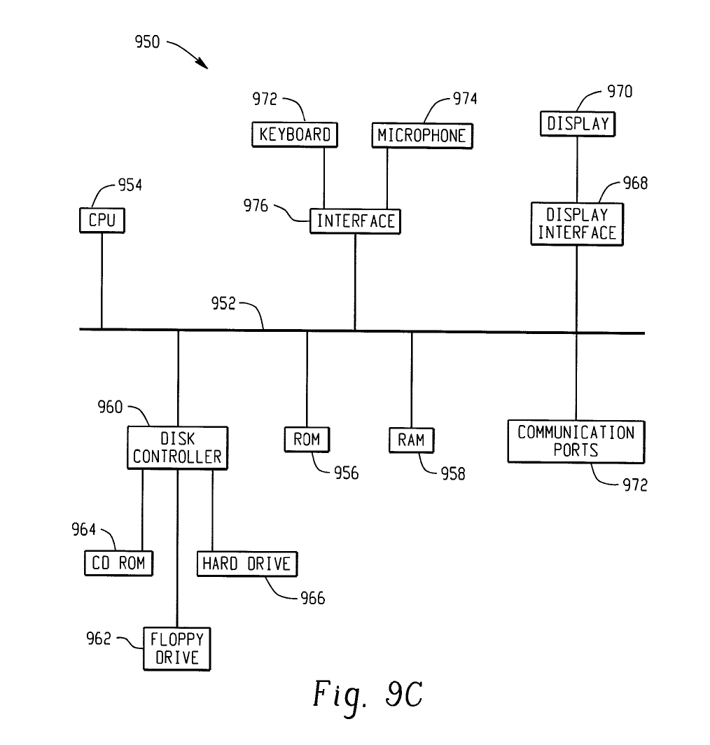

FIGS. 9A, 9B, and 9C depict example systems for simulating a portfolio risk of a portfolio managed according to one or more portfolio management rules. For example, FIG. 9A depicts an exemplary system 900 that includes a stand alone computer architecture where a processing system 902 (e.g., one or more computer processors) includes a system for simulating a portfolio risk 904 being executed on it. The processing system 902 has access to a computer-readable memory 906 in addition to one or more data stores 908. The one or more data stores 908 may contain risk factors 910 as well as portfolio management rules 912.

FIG. 9B depicts a system 920 that includes a client server architecture. One or more user PCs 922 access one or more servers 924 running a system for simulating a portfolio risk 926 on a processing system 927 via one or more networks 928. The one or more servers 924 may access a computer readable memory 930 as well as one or more data stores 932. The one or more data stores 932 may contain risk factors 934 as well as portfolio management rules 936.

FIG. 9C shows a block diagram of exemplary hardware for a stand alone computer architecture 950, such as the architecture depicted in FIG. 9A, that may be used to contain and/or implement the program instructions of system embodiments of the present invention. A bus 952 may serve as the information highway interconnecting the other illustrated components of the hardware. A processing system 954 labeled CPU (central processing unit) (e.g., one or more computer processors), may perform calculations and logic operations required to execute a program. A processor-readable storage medium, such as read only memory (ROM) 956 and random access memory (RAM) 958, may be in communication with the processing system 954 and may contain one or more programming instructions for simulating a portfolio risk of a portfolio managed according to one or more portfolio management rules. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 960 interfaces with one or more optional disk drives to the system bus 952. These disk drives may be external or internal floppy disk drives such as 962, external or internal CD-ROM, CD-R, CD-RW or DVD drives such as 964, or external or internal hard drives 966. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 960, the ROM 956 and/or the RAM 958. Preferably, the processor 954 may access each component as required.

A display interface 968 may permit information from the bus 952 to be displayed on a display 970 in audio, graphic, or alphanumeric format. Communication with external devices may optionally occur using various communication ports 972.

In addition to the standard computer-type components, the hardware may also include data input devices, such as a keyboard 973, or other input device 974, such as a microphone, remote control, pointer, mouse and/or joystick.

This written description uses examples to disclose the invention, including the best mode, and also to enable a person skilled in the art to make and use the invention. The patentable scope of the invention may include other examples. For example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It may be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method for simulating a portfolio risk of a portfolio managed according to one or more portfolio management rules, comprising:
receiving an initial holding amount of an investment instrument;
receiving a portfolio management rule related to conditions for buying or selling the investment instrument;
simulating one or more risk factors that affect the value of the investment instrument a first time period into the future;
determining an adjustment amount for the holding amount of the investment instrument based on the portfolio management rule and the one or more risk factors simulated a first time period into the future;
adjusting the holding amount of the investment instrument based on the adjustment amount;
simulating the one or more risk factors a second time period into the future; and
calculating a portfolio risk value based on the adjusted holding amount and the one or more risk factors simulated a second time period into the future.

2. The method of claim 1, further comprising determining a second adjustment amount based on the portfolio management rule and the one or more risk factors simulated a second time period into the future; and
adjusting the holding amount of the investment instrument based on the second adjustment amount.

3. The method of claim 2, further comprising:
simulating the one or more risk factors a third time period into the future; and
calculating a second portfolio risk value based on the adjusted holding amount and the one or more risk factors simulated a third time period into the future.

4. The method of claim 1, further comprising:
repeating the steps of simulating one or more risk factors a first time period into the future, determining an adjustment amount, adjusting the holding amount, and simulating the one or more risk factors a second time period into the future a plurality of times.

5. The method of claim 4, further comprising generating a distribution based on the repeated steps;
wherein the portfolio risk value is calculated based on the distribution.

6. The method of claim 5, wherein the portfolio risk value is a value at risk (VaR) measure calculated based on the distribution.

7. The method of claim 6, wherein the value at risk (VaR) measure is calculated with a 95% confidence based on the distribution.

8. The method of claim 1, wherein simulating one or more risk factors a first time period and simulating one or more risk factors a second time period uses a Monte Carlo simulation method.

9. The method of claim 1, wherein the portfolio risk value is an expected return, a portfolio value variance, a portfolio value standard deviation, an expected return confidence interval, an expected portfolio value, or a risk distortion measure.

10. A computer-implemented system for simulating a portfolio risk of a portfolio managed according to one or more portfolio management rules, comprising:
a data processor;
a computer-readable memory encoded with instructions for commanding a data processor to perform steps comprising:
receiving an initial holding amount of an investment instrument;
receiving a portfolio management rule related to conditions for buying or selling the investment instrument;
simulating one or more risk factors that affect the value of the investment instrument a first time period into the future;
determining an adjustment amount for the holding amount of the investment instrument based on the portfolio management rule and the one or more risk factors simulated a first time period into the future;
adjusting the holding amount of the investment instrument based on the adjustment amount;
simulating the one or more risk factors a second time period into the future; and
calculating a portfolio risk value based on the adjusted holding amount and the one or more risk factors simulated a second time period into the future.

11. The system of claim 10, wherein the steps further comprise determining a second adjustment amount based on the portfolio management rule and the one or more risk factors simulated a second time period into the future; and
adjusting the holding amount of the investment instrument based on the second adjustment amount.

12. The system of claim 11, wherein the steps further comprise:
simulating the one or more risk factors a third time period into the future; and
calculating a second portfolio risk value based on the adjusted holding amount and the one or more risk factors simulated a third time period into the future.

13. The system of claim 10, wherein the steps further comprise:
repeating the steps of simulating one or more risk factors a first time period into the future, determining an adjustment amount, adjusting the holding amount, and simulating the one or more risk factors a second time period into the future a plurality of times.

14. The system of claim 13, wherein the steps further comprise generating a distribution based on the repeated steps;
wherein the portfolio risk value is calculated based on the distribution.

15. The system of claim 14, wherein the portfolio risk value is a value at risk (VaR) measure calculated based on the distribution.

16. The system of claim 15, wherein the value at risk (VaR) measure is calculated with a 95% confidence based on the distribution.

17. The system of claim 10, wherein simulating one or more risk factors a first time period and simulating one or more risk factors a second time period uses a Monte Carlo simulation method.

18. The system of claim 10, wherein the portfolio risk value is an expected return, a portfolio value variance, a portfolio value standard deviation, an expected return confidence interval, an expected portfolio value, or a risk distortion measure.

19. A computer-readable memory encoded with instructions for commanding a data processor to perform steps comprising:
receiving an initial holding amount of an investment instrument;
receiving a portfolio management rule related to conditions for buying or selling the investment instrument;
simulating one or more risk factors that affect the value of the investment instrument a first time period into the future;
determining an adjustment amount for the holding amount of the investment instrument based on the portfolio management rule and the one or more risk factors simulated a first time period into the future;
adjusting the holding amount of the investment instrument based on the adjustment amount;
simulating the one or more risk factors a second time period into the future; and
calculating a portfolio risk value based on the adjusted holding amount and the one or more risk factors simulated a second time period into the future.
